(19) United States
(12) Patent Application Publication
(10) Pub. No.: US 2016/0269897 A1
(43) Pub. Date: Sep. 15, 2016

(54) ACCESS POINT AND SYSTEM CONSTRUCTED BASED ON THE ACCESS POINT AND ACCESS CONTROLLER

(71) Applicant: CHENGDU SKSPRUCE TECHNOLOGY, INC., Chengdu, Sichuan (CN)

(72) Inventors: Yongcheng Lei, Chengdu, Sichuan (CN); Fang WU, Chengdu, Sichuan (CN); Xiang GAO, Chengdu, Sichuan (CN)

(73) Assignee: CHENDU SKSPRUCE TECHNOLOGY, INC., Chengdu, Sichuan (CN)

(21) Appl. No.: 14/409,460

(22) PCT Filed: May 6, 2014
(86) PCT No.: PCT/CN2014/076894

§ 371 Date: Dec. 18, 2014

(30) Foreign Application Priority Data
Jul. 11, 2013 (CN) 201310291405.0

(51) Int. Cl. H04W 12/06; H04W 12/04

(52) U.S. Cl. CPC H04W 12/06; H04W 12/04

(57) ABSTRACT

This invention provides an access point and a system constructed based on the access point and an access controller. The access point includes a judgment module configured to judge whether the access point loses connection with an access controller; a first acquisition module configured to acquire a pre-stored user information list when the access point loses connection with the access controller, the user information list including identity authentication status of online users connected to said access point; and a second acquisition module configured to acquire authenticated online users according to the identity authentication status in said user information list, so that said access point would continue to serve the authenticated online users. This invention can improve user experience.

### TECHNICAL FIELD

This invention relates to the field of wireless technology, especially relates to an access point and a system constructed based on the access point and an access controller.

### BACKGROUND ART

WLAN (Wireless Local Area Network) refers to a group of computers and associated devices which are interconnected via IEEE 802.11 wireless techniques. WLAN refers to computer Local Area Network which transmits data via wireless channels as transmission medium. WLAN is an extension and also an important supplement of wired net and it has gradually become a crucial component of computer network. WLAN widely applies to fields in which mobile data are processed and physical transmission medium cabling is untouchable. With the formulation and development of IEEE 802.11 wireless network standard, the wireless network technologies are becoming more and more mature and perfect. WLAN has been widely used in many industries, such as financial securities, education, large-scale enterprise, industrial port, government, hotels, airport, military, etc. WLAN products mainly include wireless access point, wireless network card, wireless router, wireless gateway, wireless bridge, etc.

There are two modes in WLAN, namely IBSS (Independent Basic Service Set, also known as Ad-hoc) and BSS (Basic Service Set, also known as infrastructure). In IBSS infrastructure, user terminals directly communicate via wireless connection, and no particular equipments are needed to make mediate communication. In BSS infrastructure, user terminals communicate via mediation of an access point (AP), and Internet service can be accessed through the AP.

WLAN network falls into two kinds of architecture, namely Autonomous Management Architecture and Centralized Management Architecture. In the Autonomous Management Architecture, all the work of WLAN is completed by the AP, so the Autonomous Management Architecture is also called “Fat-AP Architecture”. The AP of the Fat-AP Architecture directly controls access and authentication process of WLAN users, and can achieve functions such as encryption of user data, authentication of a user, QoS, etc. Each AP is a separate node, independent of configuration, its channel and power, with extremely convenient installation, thus the Fat-AP Architecture is widely applied in WLAN in early stage. Along with the massive deployment of enterprises, management cost such as configuration and upgrading on the AP, data acquisition and optimization is increasingly high. Furthermore, it is also more difficult for the Fat-AP Architecture to extend to large, chain type of wireless local area network and add advanced application, making the application of WLAN tend to the Centralized Management Architecture. In the Centralized Management Architecture, all the wireless access functions are realized by both the AP and an access controller (AC), hence this architecture is also called “Fit-AP Architecture”. FIG. 1 shows a topological graph used in WLAN by operators. AC realizes the vital functions in the network, such as mobility management, authentication, channel classification, RF, resource management and packets forwarding, etc. The AP offers wireless controls, which include emission, detection and response of wireless signals, encryption and decryption of data, data transmission confirmation, data priority management, etc. The AP and the AC communicate with each other mainly through tunnel protocols, such as Control And Provisioning of Wireless Access Points (CAPWAP). Under this mechanism there exists two modes, i.e, local forwarding and centralized forwarding. As for the local forwarding mode, AC only offers management service for the AP, and the business data are forwarded locally. Management messages of the AP are encapsulated by CAPWAP tunnel to the AC. On the other hand, business data of the AP without CAPWAP encapsulation are forwarded to switching equipment by the AP and forwarded directly. The advantage of local forwarding is that data flows do not need to be capsulated through tunnel and the forwarding performance relies on throughput of local L2 forwarding. Data flows forwarded locally but without passing through AC result in weaker security. Centralized forwarding is also called as tunnel forwarding. Both management messages of the AP and data flow are encapsulated to the AC via tunnel. The advantage of centralized forwarding is that both management messages and data flow pass through the AC, which makes easier and safer management strategies to wireless users while it requires high forwarding performance of the AC. The forwarding performance of AC determines the max number of the access points and stations connected concurrently.

In the Centralized Management Architecture of the AP and the AC, the AP is managed by the AC via CAPWAP protocol under local forwarding mode and user data are forwarded locally. The AC realizes the vital functions in the network, such as mobility management, authentication, channel classification, RF, resource management and packets forwarding, etc. The AP offers wireless controls, which include emission, detection and response of wireless signals, encryption and decryption of data, data transmission confirmation, data priority management, etc, and forwarding of user data. Currently, the AP would stop service and turn the clients offline when the connection between the AC and the AP breaks, which will give rise to worse user experience (UE).

### DISCLOSURE OF THE INVENTION

### 1. The Technical Problems to be Solved

The subject invention described herein ensures the UE when the connection between the AC and the AP breaks.

### 2. Technical Proposal

In order to solve the technique problems discussed above, this invention provides an access point (AP) including:

a judgment module configured to judge whether the AP loses connection with an access controller (AC);

a first acquisition module configured to acquire a pre-stored user information list when the AP loses connection with the AC, the user information list including identity authentication status of online users connected to the AP; and

a second acquisition module configured to acquire authenticated online users according to the identity authentication status in said user information list, so that said AP would continue to serve the authenticated online users.

Optionally, the user information list further includes a key list of the online users connected to the AP, said key list is used to offer encryption and decryption keys for said authenticated online users continuously when said AP loses connection with said AC, and said AP further includes:

a key negotiation module configured to negotiate with said authenticated online users about keys and update said key list on the basis of the negotiated result when said authenticated online users' keys get expired.

Optionally, said user information list further includes IP address information of said authenticated online users, and said AP further includes:

an interception module configured to intercept DHCP requests from said authenticated online users whose IP addresses expire; and

a first transmission module configured to send IP renewal command for said users who send DHCP requests according to the IP address information, so that said users who send said DHCP requests could continue to use the expired IP address.

Optionally, said AP further includes: a network creation module configured to creates a temporary network for access of new users when said AP loses connection with said AC.

Optionally, said AP further includes: an access denial module configured to forbid said new users from accessing original network when said AP loses connection with said AC, the original network refers to the network which was set before said AP lost connection with said AC.

In order to solve the problems mentioned above, the embodiment of this invention further provides a system constructed based on an access point (AP) and an access controller (AC), said system includes the AC and any AP mentioned above.

Optionally, said AP further includes:

a first receiving module configured to receive a network configuration file from said AC when said AP gets reconnection from said AC;

a first judgment module configured to judge whether version number of the network configuration file received by the first receiving module is the same as the one which is currently used by said AP;

a first execution module configured to discard the received network configuration file when the output of the first judgment module is TRUE; and

a second execution module configured to make network configuration according to the received network configuration file when the output of the first judgment module is FALSE.

Optionally, said AP further includes a second transmission module which sends the version number of the network configuration file used currently by said AP when said AP gets reconnection with said AC; and said AC includes:

a second receiving module configured to receive the version number sent from said AP;

a second judgment module configured to judge whether the version number received by the second receiving module is the same as that of the network configuration file which would be sent by said AC;

a third execution module configured to cancel the transmission of the prepared network configuration file to said AP when the output of the second judgment module is TRUE; and

a fourth execution module configured to transmit the prepared network configuration file to said AP when the output of the second judgment module is FALSE.

Optionally, said AC includes:

a third acquisition module configured to acquire a pre-stored network-configuration-file information list when the connection between said AC and said AP is recovered, the said network-configuration-file information list contains version number and valid duration of a current network configuration file which is used by said AP;

a third judgment module configured to judge whether the version number of the current network configuration file acquired by said third acquisition module is the same as that of the network configuration file which would be sent by said AC;

a fifth execution module configured to cancel the transmission of the prepared network configuration file to said AP when the output of the second judgment module is TRUE and the current time is within the valid duration; and

a sixth execution module configured to transmit the prepared network configuration file to said AP when the output of the second judgment module is FALSE or the current time is out of the valid duration.

### 3. Beneficial Effects

In the embodiment of this invention, the AP can continue to serve the authorized users on the basis of identity authentication status information in the user information list which can judge authorized users (users who are authenticated) and unauthorized users (users who are unauthenticated) when the AP loses connection with the AC. This avoids the situation that the AP disconnected from AC stops network services for the authorized users and ensures better UE.

### BRIEF DESCRIPTION OF DRAWING

FIG. 1 is a topological graph of centralized control mode provided by the prior art; and

FIG. 2 is a structure chart of an access point provided by an embodiment of this invention.

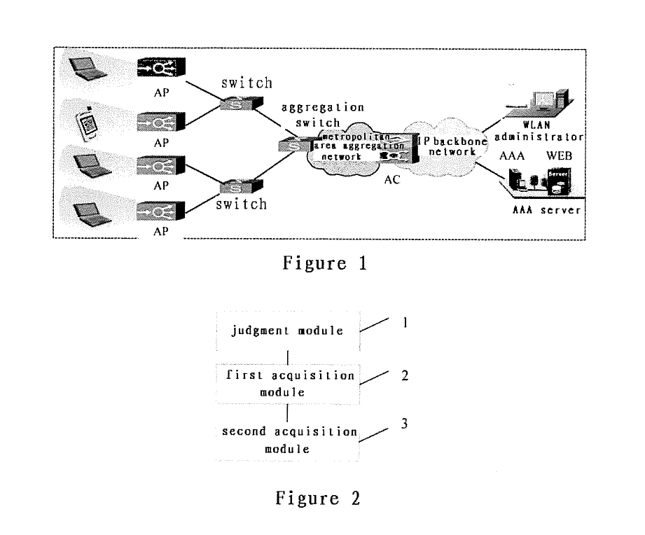

### DETAILED DESCRIPTION OF EMBODIMENTS

FIG. 2 is a structure chart of an access point (AP) provided by an embodiment of this invention. The AP includes:

a judgment module 1 configured to judge whether the AP loses connection with an access controller (AC);

a first acquisition module 2 configured to acquire a pre-stored user information list when the AP loses connection with the AC, the user information list including identity authentication status of online users connected to said AP, wherein, the user information list could mark the online users of the AP by Media Access Control address (MAC address); and

a second acquisition module 3 configured to acquire authenticated online users according to the identity authentication status in said user information list, so that said AP would continue to serve the authenticated online users.

In the embodiment of this invention, the AP can continue to serve the authorized users on the basis of identity authentication status information in the user information list which can judge authorized users (users who are authenticated) and unauthorized users (users who are unauthenticated) when the AP loses connection with the AC. This avoids the situation that the AP disconnected from the AC stops network services for the authorized users and ensures better UE.

Optionally, the user information list further includes a key list of the online users connected to the AP, said key list is used to offer encryption and decryption keys for said authenticated online users continuously when said AP loses connection with said AC, so that said AP encrypts and decrypts to data of the online users. Said AP further includes:

a key negotiation module configured to negotiate with said authenticated online users about keys and update said key list on the basis of the negotiated result when said authenticated online users' keys get expired.

Specifically, when the AP loses connection with the AC, the AP continuously decrypts and encrypts user data according to the key list. When the users' keys get expired, the AP negotiates about keys with users.

Optionally, said user information list further includes IP address information of said authenticated online users. The AP further includes:

an interception module configured to intercept DHCP requests from said authenticated online users whose IP addresses expire; and

a first transmission module configured to send IP renewal command for said users who send DHCP requests according to the IP address information, so that said users who send said DHCP requests could continue to use the expired IP address.

Specifically, when users' IP addresses are assigned from non-local network, for example, the users' IP addresses are assigned by AC, the user information list of the AP also includes the users' IP address information. Users would send DHCP requests to network when their IP addresses expire. The AP would intercept these requests at this moment and reply these requests with the identity of users' DHCP request destination, so as to avoid the problem that the users are turned offline because IP address cannot be renewal.

Since the user authentication function resides at AC, new users can not pass the authentication and access network when the AP loses connection with the AC. In order to solve the above problem, optionally, said AP also includes:

a network creation module configured to creates a temporary network for access of new users when said AP loses connection with said AC.

Specifically, said AP would create a new SSID network for new users to access temporarily when the AP find itself not associated with the AC. The authentication mode of this SSID network could be open or local authentication, such as WEP authentication and WPA-PSK authentication, etc. The network would limit the users' network resources (such as bandwidth) and accessible internet resources (such as website address) because of lower authentication level. The AP reconnected to AC needs to disable the SSID network timely and the users in the SSID network need to be re-authenticated and accessed to corresponding SSID. For better UE, the AP notifies the users that this network would be disabled before this network gets disabled. A web page with certain notification to client terminal or a webpage access request jumping to notification web can be push means.

In the meantime, there exists a problem that new users might join the original network by fault. Authentication can not be executable since the AP is disconnected with the AC. Authentication failure would result in worse UE. To solve the problem, the AP would stop new users from joining the original network (deny the network association request of the new users, for instance) when they find themselves disconnected with AC. Optionally, said AP also includes:

access denial module configured to forbid said new users from accessing original network when said AP loses connection with said AC, the original network refers to the network which was set before said AP lost connection with said AC. Access denial approaches could be to send access denial command or not to send access permission command to the new users.

In the embodiment of this invention, the AP can continue to serve the authorized users on the basis of identity authentication status information in the user information list which can judge authorized users (users who are authenticated) and unauthorized users (users who are unauthenticated) when the AP loses connection with the AC. This avoids the situation that the AP disconnected from AC stops network services for the authorized users and ensures better UE. In addition, when the AP find itself not associated with the AC, the AP creates a new SSID network for new users to access temporarily. This further ensures better UE.

In addition, the embodiment of this invention further provides a system constructed based on an access point (AP) and an access controller (AC), said system includes the AC and any AP mentioned above.

As we know, the AC would send a network configuration file to the AP according to established procedures when the AP recovers the connection with the AC. Even if the received configuration file makes no difference with the one which is currently used, the AP would make reconfiguration and restart the network and services. To solve this problem, optionally, the AP in said system also includes:

a first receiving module configured to receive a network configuration file from said AC when said AP gets reconnection from said AC; a first judgment module configured to judge whether version number of the network configuration file received by the first receiving module is the same as the one which is currently used by said AP; a first execution module configured to discard the received network configuration file when the output of the first judgment module is TRUE; and a second execution module configured to make network configuration according to the received network configuration file when the output of the first judgment module is FALSE.

Specifically, each configuration file has got a version number. The AP would compare the version number of the received configuration file with the one that is currently used. The AP would reconfigure if the two version numbers are inconsistent. Otherwise, the AP would ignore the received configuration file, continue to use the configuration file that is currently used and do not intercept the network.

In addition, the mode given below is acceptable.

Said AP also includes a second transmission module which sends the version number of the network configuration file used currently by said AP when said AP gets reconnection with said AC.

Said AC includes a second receiving module configured to receive the version number sent from said AP; a second judgment module configured to judge whether the version number received by the second receiving module is the same as that of the network configuration file which would be sent by said AC; a third execution module configured to cancel the transmission of the prepared network configuration file to said AP when the output of the second judgment module is TRUE; and a fourth execution module configured to transmit the prepared network configuration file to said AP when the output of the second judgment module is FALSE.

Specifically, each configuration file has got a version number. When the connection between the AP and the AC is set, the AP would report its version number to the AC (if there is no currently-used configuration file, such situation would be described by a particular value of version number, for example, all zero). The AC would compare the version number of the configuration file which is currently-used by the AP and the one which is intended to be sent to the AP. The AC would send the configuration file if the two version numbers are inconsistent. Otherwise, the AC would cancel the transmission of the configuration file. Optionally, the AC expressly informs the AP that there is no need to update the configuration file.

In addition, the mode given below is acceptable.

Said AC includes: a third acquisition module configured to acquire a pre-stored network-configuration-file information list when the connection between said AC and said AP is recovered, the said network-configuration-file information list contains version number and valid duration of a current network configuration file which is used by said AP; a third judgment module configured to judge whether the version number of the current network configuration file acquired by said third acquisition module is the same as that of the network configuration file which would be sent by said AC; a fifth execution module configured to cancel the transmission of the prepared network configuration file to said AP when the output of the second judgment module is TRUE and the current time is within the valid duration; and a sixth execution module configured to transmit the prepared network configuration file to said AP when the output of the second judgment module is FALSE or the current time is out of the valid duration.

Specifically, each configuration file has got a version number. AC sets for each AP a configure-file information list which records version number and valid duration timer of the network configuration file. AC would erase the version number of the configuration file or set particular value (for example, all zero) when the valid duration timer expires. AC would compare the version number of the network configuration file sent and saved and the one which would be sent to the AP when the configuration file needs to be sent to the AP for the next time, for example, when the AP reconnects with the AC. The AC would send the configuration file if the two version numbers are inconsistent. Otherwise, the AC would cancel the transmission of the network configuration file. Optionally, the AC expressly informs the AP that there is no need to update the configuration file.

In the system constructed based on the AP and the AC provided by the embodiment of this invention, the AP can continue to serve the authorized users on the basis of identity authentication status information in the user information list which can judge authorized users (users who are authenticated) and unauthorized users (users who are unauthenticated) when the AP loses connection with the AC. This avoids the situation that the AP disconnected from the AC stops network services for the authorized users and ensures better UE. In addition, each configuration file has got a version number. The version number of the current network configuration file and the one which would be sent by AC can be compared when the connection between said AC and said AP recovers. This avoids a situation that the AP still reconfigures and breaks the network services when the AP and the AC share the same version of the configuration file. This also provides better UE.

What is claimed is:

1. An access point including:
a judgment module configured to judge whether the access point loses connection with an access controller;
a first acquisition module configured to acquire a pre-stored user information list when the access point loses connection with the access controller, the user information list including identity authentication status of online users connected to said access point; and
a second acquisition module configured to acquire authenticated online users according to the identity authentication status in said user information list, so that said access point would continue to serve the authenticated online users.

2. The access point according to claim 1, wherein the user information list further includes a key list of the online users connected to the access point, said key list is used to offer encryption and decryption keys for said authenticated online users continuously when said access point loses connection with said access controller, and said access point further includes:
a key negotiation module configured to negotiate with said authenticated online users about keys and update said key list on the basis of the negotiated result when said authenticated online users' keys get expired.

3. The access point according to claim 1, wherein said user information list further includes IP address information of said authenticated online users, and said access point further includes:
an interception module configured to intercept DHCP requests from said authenticated online users whose IP addresses expire; and
a first transmission module configured to send IP renewal command for said users who send DHCP requests according to the IP address information, so that said users who send said DHCP requests could continue to use the expired IP address.

4. The access point according to claim 1, wherein the access point further includes:
a network creation module configured to creates a temporary network for access of new users when said access point loses connection with said access controller.

5. The access point according to claim 4, wherein the access point further includes:
an access denial module configured to forbid said new users from accessing original network when said access point loses connection with said access controller, the original network refers to the network which was set before said access point lost connection with said access controller.

6. A system constructed based on an access point and an access controller, said system includes the access controller and the access point according to any of claims 1 to 5.

7. The system constructed based on an access point and an access controller according to claim 6, wherein the access point further includes:
a first receiving module configured to receive a network configuration file from said access controller when said access point gets reconnection from said access controller;
a first judgment module configured to judge whether version number of the network configuration file received by the first receiving module is the same as the one which is currently used by said access point;
a first execution module configured to discard the received network configuration file when the output of the first judgment module is TRUE; and
a second execution module configured to make network configuration according to the received network configuration file when the output of the first judgment module is FALSE.

8. The system constructed based on an access point and an access controller according to claim 6, wherein the access point further includes a second transmission module which sends the version number of the network configuration file used currently by said access point when said access point gets reconnection with said access controller; and said access controller includes:
a second receiving module configured to receive the version number sent from said access point;
a second judgment module configured to judge whether the version number received by the second receiving module is the same as that of the network configuration file which would be sent by said access controller;
a third execution module configured to cancel the transmission of the prepared network configuration file to said access point when the output of the second judgment module is TRUE; and
a fourth execution module configured to transmit the prepared network configuration file to said access point when the output of the second judgment module is FALSE.

9. The system constructed based on an access point and an access controller according to claim 6, wherein the access controller includes:
a third acquisition module configured to acquire a pre-stored network-configuration-file information list when the connection between said access controller and said access point is recovered, the said network-configuration-file information list contains version number and valid duration of a current network configuration file which is used by said access point;
a third judgment module configured to judge whether the version number of the current network configuration file acquired by said third acquisition module is the same as that of the network configuration file which would be sent by said access controller;
a fifth execution module configured to cancel the transmission of the prepared network configuration file to said access point when the output of the second judgment module is TRUE and the current time is within the valid duration; and
a sixth execution module configured to transmit the prepared network configuration file to said access point when the output of the second judgment module is FALSE or the current time is out of the valid duration.
